(19) United States
(12) Patent Application Publication
(10) Pub. No.: US 2006/0197585 A1
(43) Pub. Date: Sep. 7, 2006

(54) Voltage reference generator and method of generating a reference voltage

(76) Inventors: Hyoungrae Kim, Hwaseong-City (KR); Minsoo Cho, Sungnam-si (KR); Yoonkyung Choi, Yongin-City (KR)

Correspondence Address: HARNESS, DICKEY & PIERCE, P.L.C., P.O. BOX 8910, RESTON, VA, 20195, US

(21) Appl. No.: 11/255,917

(22) Filed: Oct. 24, 2005

(30) Foreign Application Priority Data
Mar. 3, 2005 (KR) 10-2005-0017820

(51) Int. Cl. G05F 1/10

(52) U.S. Cl. 327/539

(57) ABSTRACT

According to one embodiment, the reference voltage generator generates a reference voltage which changes with temperature. For example, the reference voltage generator may generate a reference voltage that decreases as temperature increase. The reference voltage generator is configured to selectively change a temperature coefficient of the reference voltage such that at a selected temperature value, the reference voltage is a same voltage value regardless of the temperature coefficient.

### FOREIGN PRIORITY INFORMATION

The subject application claims priority under 35 U.S.C. 119 on Korean Application No. 10-2005-0017820 filed Mar. 3, 2005; the entire contents of which are hereby incorporated by reference.

### BACKGROUND OF THE INVENTION

Reference voltage generators are employed in a myriad of applications. For example, liquid crystal displays (LCD) use a reference voltage generator to generate a driver voltage used by a gate driver and a data or source driver of the LCD. In many of these applications, it is desirable to provide a reference voltage that varies with temperature to combat possible adverse affects temperature may have on the application.

FIG. 1 illustrates a conventional reference voltage generator that varies the generated reference voltage with respect to temperature. As shown, the conventional reference voltage generator includes a current mirror 51, a proportional to absolute temperature (PTAT) circuit 52 and a complementary to absolute temperature (CTAT) circuit 53.

The current mirror 51 includes a first PMOS transistor TP1, a first NMOS transistor TN1 and a first resistor R1 connected in series between a supply voltage V_{DD} and ground V_{SS}. The current mirror 51 further includes a second PMOS transistor TP2 and a second NMOS transistor TN2 connected in series between the supply voltage V_{DD} and ground V_{SS}. The gate of the first PMOS transistor TP1 is connected to the gate of the second PMOS transistor TP2. Similarly, the gate of the first NMOS transistor TN1 is connected to the gate of the second NMOS transistor TN2. The drain of the first PMOS transistor TP1 is further connected to the gate of the first PMOS transistor TP1, and the drain of the second NMOS transistor TN2 is connected to the gate of the second NMOS transistor TN2. The ratio of the area of the first NMOS transistor TN1 to the area of the second NMOS transistor TN2 is referred to the current density ratio P.

The current mirror 51 also includes a third PMOS transistor TP3 connected in parallel with the first and second PMOS transistors TP1 and TP2. The gate of the third PMOS transistor TP3 is connected to the gate of the second PMOS transistor TP2.

A proportional to absolute temperature (PTAT) circuit 52 and a complementary to absolute temperature (CTAT) circuit 53 are connected in series with the third PMOS transistor TP3 between the voltage supply V_{DD} and ground V_{SS}. The PTAT circuit 52 includes a variable resistor R2. The CTAT circuit 53 includes a bi-polar junction transistor TB. The transistor TB has its base connected to its collector.

During operation, the current mirror circuit 51 generates a current Ix that is mirrored to the PTAT and CTAT circuits 52 and 53 as current Iy. The voltage generated by the current flowing through the PTAT and CTAT circuits 52 and 53 produces the reference voltage Vref of the reference voltage generator. The PTAT circuit 52 generates a voltage Vx equal to IyR2, where Iy=mIx. Here, m is the ratio of the size of the third PMOS transistor TP3 to the size of the second PMOS transistor TP2. Further, Ix=V_{T}(ζ)(1/R1)lnP, where ζ is a process constant having a value of ˜1 to 2, and V_{T} is the thermal voltage equal to kT/q. Here, T is the temperature, k is the Boltzmann constant, and q is the elementary charge. The CTAT circuit 53 generates the voltage VBE equal to V_{T}ln(Iy/Is), where Is is the saturation current that, as is known, depends on the size of the transistor TB. Accordingly, the reference voltage Vref equals Vx+VBE.

FIG. 2 illustrates a graph showing changes in the reference voltage Vref with respect to temperature for versions of the reference voltage generating circuit of FIG. 1 having different temperature coefficients. As is known, the temperature coefficient is the rate of voltage change with respect to changes in temperature.

### SUMMARY OF THE INVENTION

The present invention relates to a reference voltage generator.

One embodiment of the present invention includes a reference voltage generating circuit that generates a reference voltage which changes with temperature. For example, the reference voltage generating circuit may generate a reference voltage that decreases as temperature increases. The reference voltage generating circuit is configured to selectively change a temperature coefficient of the reference voltage such that at a selected temperature value, the reference voltage is a same voltage value regardless of the temperature coefficient.

In one embodiment, the reference voltage generating circuit combines a first voltage and a second voltage to produce the reference voltage. The first voltage may be a temperature dependent voltage, and the second voltage may be a temperature independent voltage. For example, the reference voltage generating circuit may respectively weight the first and second voltages, and subtract the weighted first voltage from the weighted second voltage. The reference voltage generating circuit may also be configured to selectively vary the respective weights, and varying the respective weights causes the temperature coefficient of the reference voltage to vary.

In one embodiment, the reference voltage generator includes a first voltage generator generating the first voltage, and a second voltage generator generating the second voltage. The first voltage generator may include a second and third resistor connected in series, and a resistance varying element connected in parallel with the third resistor. The resistance varying element may be configured to be adjustable such that the first voltage generating circuit generates a desired voltage value at the selected temperature value. For example, the desired voltage value may be the second voltage. The second voltage generator may include a proportional to absolute temperature element connected in series with a complementary to absolute temperature element.

According to one embodiment, the voltage reference generator includes a first voltage generator generating a first voltage, a second voltage generator generating a second voltage. A voltage subtractor respectively weights the first and second voltages and subtracts the weighted first voltage from the weighted second voltage to produce the reference voltage.

The present invention also relates to a method of generating a reference voltage.

One embodiment of this method includes generating a reference voltage that changes with temperature, and at a selected temperature value is a same voltage value regardless of a temperature coefficient of the reference voltage. In one example, the generating step may generate a reference voltage that decreases as temperature increases.

In one embodiment, the generating step includes weighting the first and second voltages, and subtracting the weighted first voltage from the weighted second voltage. The first voltage may be a temperature dependent voltage, and the second voltage may be a temperature independent voltage.

In one embodiment, the generating step further includes selectively varying the respective weights to vary the temperature coefficient of the reference voltage.

In an embodiment, the method may further include generating the first voltage based on a resistance value and generating the second voltage. The generating the first voltage step may include adjusting the resistance value such that the first voltage is a desired voltage value at a selected temperature value. For example, the desired voltage value may be the second voltage.

The present invention also relates to applications employing a reference voltage generator such as a display driver circuit.

For example, one embodiment of a display driver circuit may include a voltage generator generating a gate driver voltage and a source driver voltage. The voltage generator may include a reference voltage generator that generates a reference voltage according to an embodiment of the present invention, and the voltage generator generates at least the gate driver voltage based on the reference voltage. A source driver may generate driver signals for a display panel based on the source driver voltage, and a gate driver may generate gate driving signals for the display panel based on the gate driver voltage. In one embodiment, the reference voltage generator generates a reference voltage that decreases with increases in temperature such that the gate driving signals decrease as the temperature increases.

### BRIEF DESCRIPTION OF THE DRAWINGS

The present invention will become more fully understood from the detailed description given herein below and the accompanying drawings, wherein like elements are represented by like reference numerals, which are given by way of, illustration only and thus are not limiting of the present invention and wherein:

FIG. 1 illustrates a conventional voltage reference generator;

FIG. 2 illustrates a graph of reference voltage with respect to temperature for the voltage reference generator of FIG. 1 having different temperature coefficients;

FIG. 3 illustrates a reference voltage generator according to an embodiment of the present invention.

FIG. 4 illustrates an example of the first and second voltages V1 and V2 in FIG. 3 with respect to temperature where the first voltage V1 has a temperature coefficient of +0.2%/° C.;

FIG. 5 illustrates the reference voltage Vref with respect to changes in temperature for the reference voltage generator of FIG. 3 where the temperature coefficient is −0.5%/° C.

FIG. 6 illustrates the current mirror, the PTAT circuit and the TIVG circuit of FIG. 3 in detail according to a first example embodiment of the present invention;

FIG. 7 illustrates the reference voltage Vref versus temperature for reference voltage generators according to the present invention having different temperature coefficients;

FIG. 8 illustrates the current mirror, the PTAT circuit and the TIVG circuit of FIG. 3 in detail according to a second example embodiment of the present invention;

FIG. 9 illustrates an example application for the reference voltage generator according to the present invention; and

FIG. 10 illustrates the change in gate voltage versus changes in temperature when a reference voltage generator according to an embodiment of the present invention is used in the display driver circuit of FIG. 9.

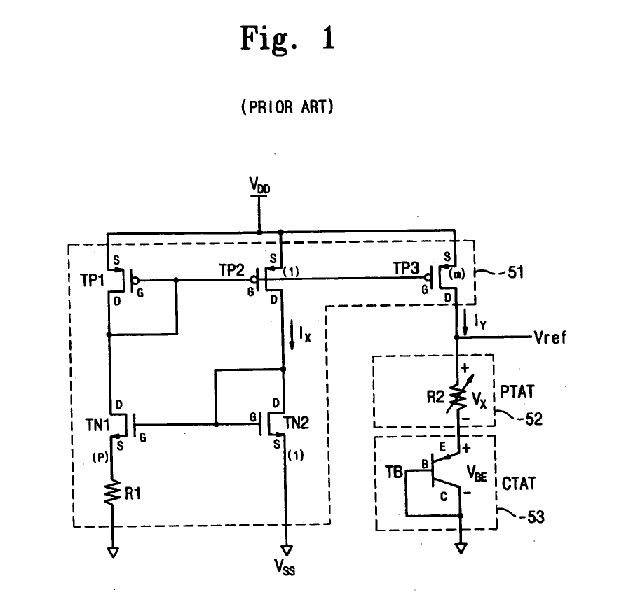

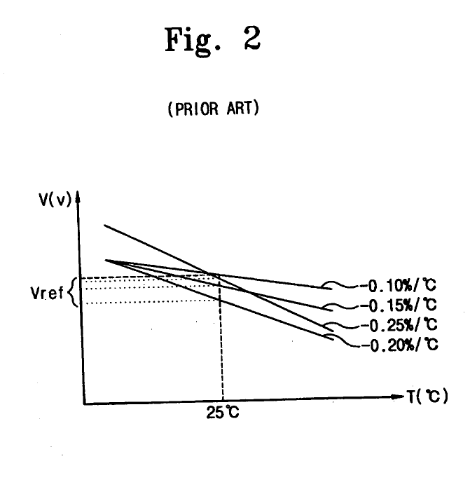

### DETAILED DESCRIPTION OF EXAMPLE EMBODIMENTS

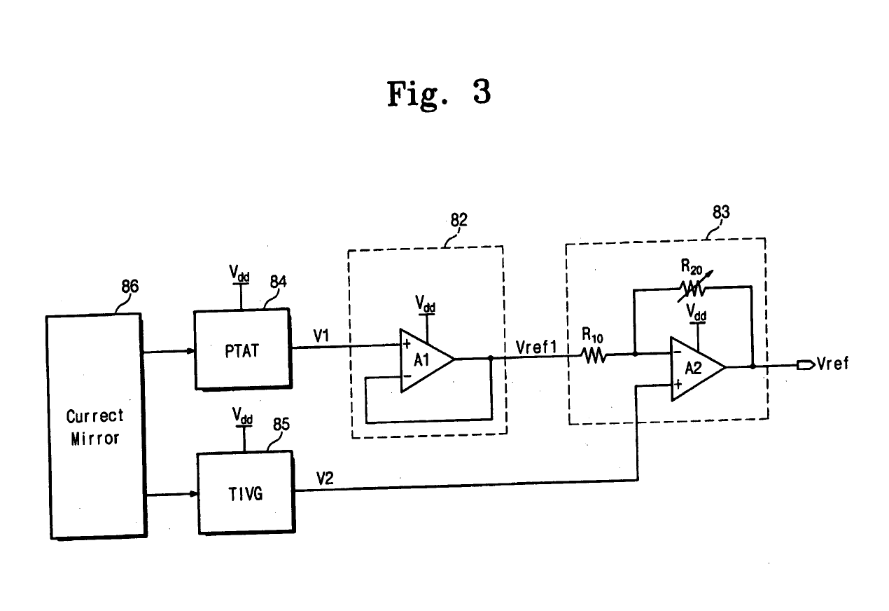

FIG. 3 illustrates a reference voltage generator according to an embodiment of the present invention. As shown, the reference voltage generator includes a current mirror 86, a proportional to absolute temperature (PTAT) circuit 84 and a temperature independent voltage generating (TIVG) circuit 85. Based on current supplied by the current mirror 86, the PTAT circuit 84 and the TIVG circuit 85 generate first and second voltages V1 and V2, respectively. A buffer amplifier 82 buffers the first voltage V1, and a voltage combiner 83 combines the buffered first voltage V1 and the second voltage V2 to generate the reference voltage Vref.

The PTAT circuit 84 generates the first voltage V1 proportional to changes in temperature at an established temperature coefficient (e.g., +0.2%/° C.). By contrast, the TIVG circuit 85 generates the same second voltage V2 regardless of changes in temperature. Both the PTAT circuit 84 and the TIVG circuit 85 will be described in detail below along with the current mirror 86.

The buffer circuit 82 includes a first operational amplifier A1 having its output connected to its negative input and receiving the first voltage V1 at its positive input. The buffer circuit 82 serves to block unnecessary current from the PTAT circuit 84. The voltage combiner 83 includes a second operational amplifier A2. The positive input of the second operational amplifier A2 receives the second voltage V2. The negative input of the second operational amplifier A2 receives the buffered, first voltage V1 via a first resistor R10. The negative input of the second operational amplifier A2 is also connected to the output of the second operational amplifier A2 via a second resistor R20. Accordingly, it will be understood that the operational amplifier A2 serves as a differential amplifier.

In operation, according to Kirchoff's current law, the current I₁ though the first resistor R10 equals the current I₂ through the second resistor R20 such that:

$${I}_{1} = {I}_{2} \frac{V 1 - V 2}{{R}_{10}} = \frac{V 2 - {V}_{ref}}{{R}_{20}} \qquad ( 1 )$$

Solving for the reference voltage Vref results in:

$${V}_{ref} = ( 1 + \frac{{R}_{20}}{{R}_{10}} ) V 2 - \frac{{R}_{20}}{{R}_{10}} V 1 \qquad ( 2 )$$

The temperature coefficient of the reference voltage Vref generated by the reference voltage generator (which also may be referred to as the temperature coefficient of the reference voltage generator) may then be expressed as:

$$\begin{matrix}\begin{matrix}Vref temperature \\ coefficient\end{matrix} = \frac{{V}_{ref} ( {T}_{b} ) - {V}_{ref} ( {T}_{a} )}{{T}_{b} - {T}_{a}} \times \\ \frac{1}{{V}_{ref} ( temp\_room )} \times 100 \\ = - \frac{{R}_{20}}{{R}_{10}} \times \frac{V 1 ( {T}_{b} ) - V 1 ( {T}_{a} )}{{T}_{b} - {T}_{a}} \times \\ \frac{1}{V 1 ( temp\_room )} \times 100 \\ = - ( \frac{{R}_{20}}{{R}_{10}} ) \times V 1 temperature coefficient\end{matrix} \qquad ( 3 )$$

where Tₐ and T_{b} are temperatures where T_{b}>Tₐ.

As shown by equation 3, the temperature coefficient of the reference voltage Vref is based on the temperature coefficient of the first voltage V1 and the ratio (R20/R10) of the resistance for second resistor R20 to the resistance of first resistor R10. As described above, and as will be described in more detail below, the temperature coefficient of the PTAT circuit 84, and therefore, the first voltage V1 is an established value. For example, the temperature coefficient of the first voltage V1 may be established as +0.2%/° C. Accordingly, the temperature coefficient of the reference voltage Vref may be determined by the ratio R20/10. For example, setting the ratio R20/R10 to 2.5 produces a temperature coefficient of −0.5% for Vref.

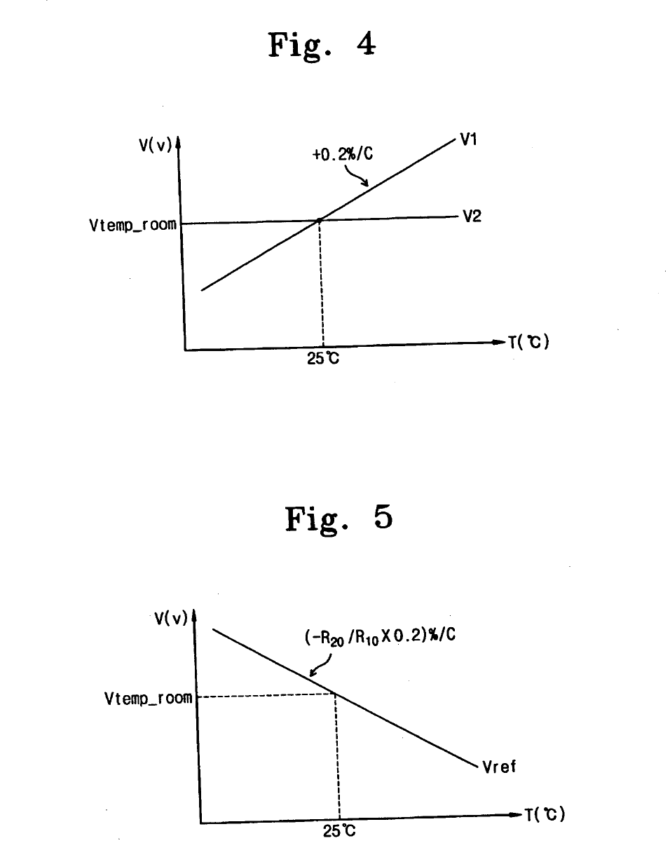

FIG. 4 illustrates an example of the first and second voltages V1 and V2 with respect to temperature where the first voltage V1 has a temperature coefficient of +0.2%/° C. For the curves illustrated in FIG. 4, FIG. 5 illustrates the reference voltage Vref with respect to changes in temperature where the temperature coefficient is −0.5%/° C.

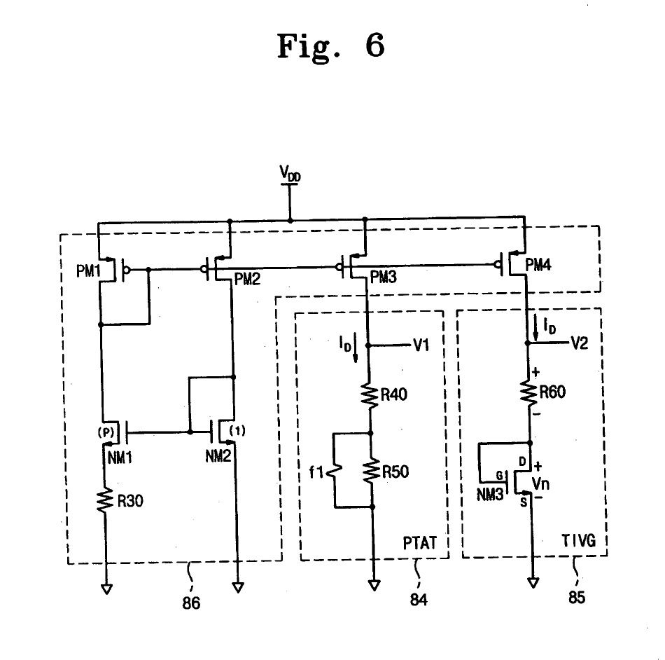

FIG. 6 illustrates the current mirror 86, the PTAT circuit 84 and the TIVG circuit 85 in detail according to a first example embodiment of the present invention. As shown, the current mirror 86 includes a first PMOS transistor PM1, a first NMOS transistor NM1 and a third resistor R30 connected in series between a supply voltage VDD and ground. The current mirror 86 further includes a second PMOS transistor PM2 and a second NMOS transistor NM2 connected in series between the supply voltage VDD and ground. The gate of the first PMOS transistor PM1 is connected to the gate of the second PMOS transistor PM2. Similarly, the gate of the first NMOS transistor NM1 is connected to the gate of the second NMOS transistor NM2. The drain of the first PMOS transistor PM1 is further connected to the gate of the first PMOS transistor PM1, and the drain of the second NMOS transistor NM2 is connected to the gate of the second NMOS transistor NM2. The ratio of the area of the first NMOS transistor NM1 to the area of the second NMOS transistor NM2 is P to 1 and is referred to the current density ratio P.

The current mirror 86 also includes a third PMOS transistor PM3 and a fourth PMOS transistor PM4 connected in parallel with the first and second PMOS transistors PM1 and PM2. The gates of the third and fourth PMOS transistors PM3 and PM4 are connected to the gate of the second PMOS transistor PM2.

The PTAT circuit 84 is connected between the third PMOS transistor PM3 and ground, and the TIVG circuit 85 is connected between the fourth PMOS transistor PM4 and ground. The PTAT circuit 84 includes fourth and fifth resistors R40 and R50 connected in series between the third PMOS transistor PM3 and ground. A fuse f1 is connected in parallel with the fifth resistor R50. The TVIG circuit 85 includes a sixth resistor R60 and a third NMOS transistor MN3 connected in series between the fourth PMOS transistor PM4 and ground. Also, the third NMOS transistor MN3 has its gate connected to its drain.

The current mirror circuit 86 supplies a same mirror current I_{D} to both the PTAT circuit 84 and the TIVG circuit 85. The TIVG circuit 85 generates the second voltage V2 according to the following expression:

$$\begin{matrix}V 2 = {V}_{n} + {I}_{D} {R}_{60} \\ = ζ \frac{kT}{q} ln \frac{{I}_{D}}{{I}_{D0} ( W / L )} + \frac{ζ {kTR}_{60}}{{qR}_{30}} ln P \\ = ζ \frac{kT}{q} ( ln \frac{{I}_{D} L}{{I}_{D0} W} + \frac{{R}_{60}}{{R}_{30}} ln P )\end{matrix} \qquad ( 4 )$$

where Vₙ is the voltage across the third NMOS transistor NM3, W is the width of the third NMOS transistor MN3 and L is the length of the third NMOS transistor MN3. As evident from equation 4, the third NMOS transistor MN3 contributes negatively to the second voltage V2 with respect to temperature while the resistor contributes positively to the second voltage V2 with respect to temperature. As a result, the TIVG circuit 85 generates a constant voltage with respect to temperature.

The PTAT circuit 84 generates the first voltage according to equation 5 below:
V1=I_{D}(R₄₀+R50//ƒ) (5)
As shown, the first voltage V1 depends in part on the resistance provided by the fuse f1. In one embodiment, the fuse f1 is created by laser fusing. The amount of fusing controls the resistance offered by the fuse f1. In another embodiment, the fuse f1 may be accomplished by a programming operation of a non-volatile memory element. However, a fuse is just one example of a resistance varying element, and any resistance varying element may be used instead of the fuse f1. For example, a transistor controlled by logic elements may also be used.

Using the resistance varying element, the first voltage V1 may be varied by varying the resistance of the resistance varying element. In one embodiment of the present invention, the resistance varying element is varied such that, at a desired temperature, the first voltage V1 equals the second voltage V2. For example, the desired temperature may by room temperature or 25° C.

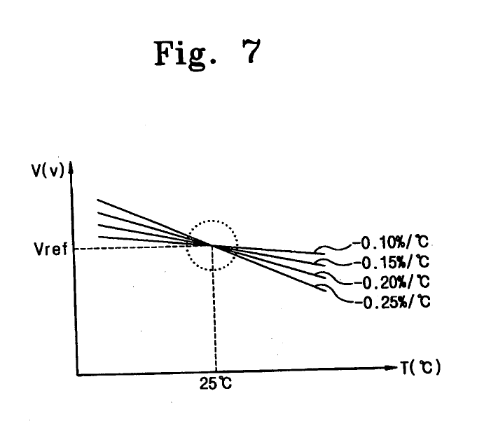

Setting the first voltage V1 equal to the second voltage V2 at a desired temperature results in the same reference voltage Vref at that desired temperature regardless of the temperature coefficient of the reference voltage Vref. This is illustrated in FIG. 7.

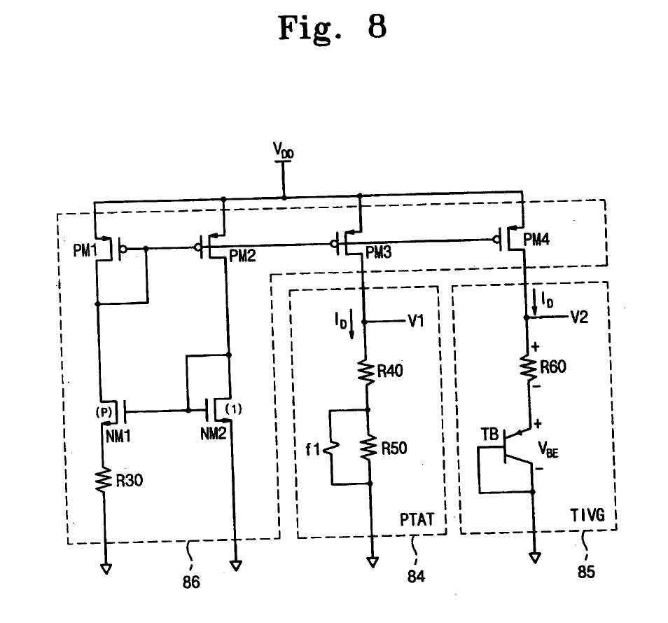

FIG. 8 illustrates the current mirror 86, the PTAT circuit 84 and the TIVG circuit 85 in detail according to a second example embodiment of the present invention. In this embodiment, the current mirror 86, the PTAT circuit 84, and the TIVG circuit 85 are the same as in the embodiment of FIG. 6, except that the third NMOS transistor NM3 in the TIVG circuit 85 has been replaced with a first bipolar transistor TB. As shown, the base of the bipolar transistor TB is connected to the collector of the first bipolar transistor TB.

As will be appreciated, the operation of this embodiment is the same as described above with respect to the embodiment of FIG. 6; and therefore, will not be described in detail for the sake of brevity.

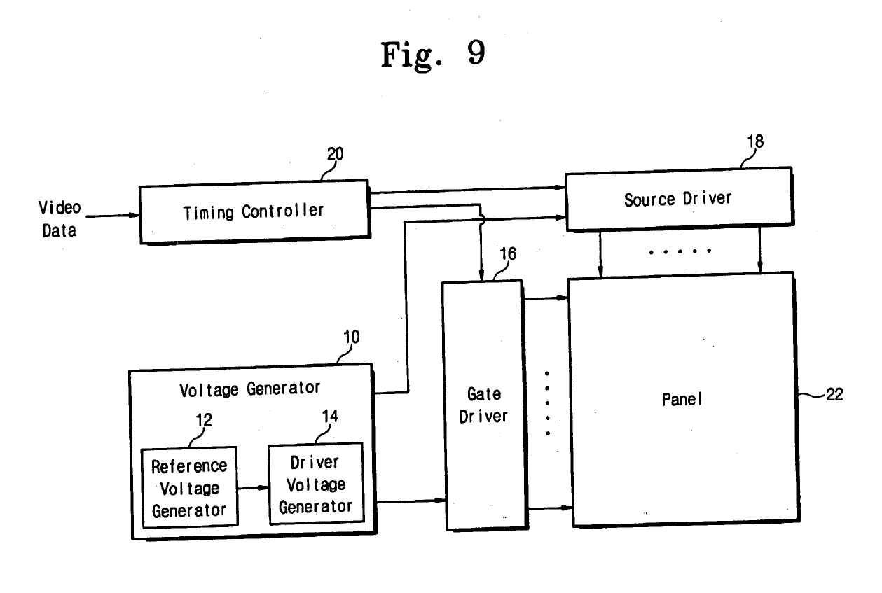

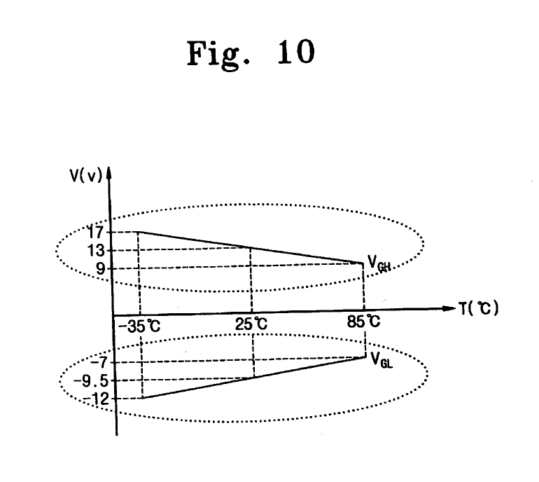

FIG. 9 illustrates an example application for the reference voltage generator according to the present invention. The example application of FIG. 9 is that of a liquid crystal display device. As shown, a voltage generator 10 includes a reference voltage generator 12 and a driver voltage generator 14. The driver voltage generator 14 uses the reference voltage generated by the reference voltage generator 12 to produce a gate driver voltage for a gate driver circuit 16. The voltage generator 10 also produces a source driver voltage for a source driver 18. The gate driver 16 and the source driver 18 also receive timing signals from a timing controller 20, which generates the timing signals based on received video data. The gate driver 16 and source driver 18, based on the timing signals and driver voltages, produce gate driving signals and source signals, respectively, to drive a liquid crystal panel 22 and display an image represented by the video data. Because the operation and structure of the elements forming the liquid crystal display device are so well-known, these elements and their operation will not be described in detail for the sake of brevity.

As will be understood, instead of a conventional reference voltage generator, the reference voltage generator according to an embodiment of the present invention may be used as the reference voltage generator 12 in FIG. 9. When the reference voltage generator according to an embodiment of the present invention is used in the liquid crystal display device, the voltage of the gate driving signals varies as shown in FIG. 10. Namely, as shown, the voltages of the gate driving signals decrease as temperature increases.

The invention being thus described, it will be obvious that the same may be varied in many ways. Such variations are not to be regarded as a departure from the invention, and all such modifications are intended to be included within the scope of the invention.

We claim:

1. A reference voltage generator, comprising:
a reference voltage generating circuit that generates a reference voltage which changes with temperature, the reference voltage generating circuit configured to selectively change a temperature coefficient of the reference voltage such that at a selected temperature value, the reference voltage is a same voltage value regardless of the temperature coefficient.

2. The reference voltage generator of claim 1, wherein the reference voltage generating circuit combines a first voltage and a second voltage to produce the reference voltage.

3. The reference voltage generator of claim 2, wherein the first voltage is a temperature dependent voltage, and the second voltage is a temperature independent voltage.

4. The reference voltage generator of claim 3, wherein the first voltage changes proportional to temperature.

5. The reference voltage generator of claim 3, wherein the reference voltage generating circuit respectively weights the first and second voltages, and subtracts the weighted first voltage from the weighted second voltage.

6. The reference voltage generator of claim 5, wherein the reference voltage generating circuit is configured to selectively vary the respective weights, and varying the respective weights causes the temperature coefficient of the reference voltage to vary.

7. The reference voltage generator of claim 3, wherein the reference voltage generating circuit comprises:
a first resistor receiving the first voltage;
an operational amplifier having a positive input and a negative input, the positive input receiving the second voltage, the negative input receiving output from the first resistor, and an output of the operational amplifier supplying the reference voltage; and
a variable resistor connected between the negative input and the output of the operational amplifier such that changing a resistance of the variable resistor changes the temperature coefficient of the reference voltage.

8. The reference voltage generator of claim 3, further comprising:
a first voltage generator generating the first voltage; and
a second voltage generator generating the second voltage.

9. The reference voltage generator of claim 8, wherein the first voltage generator includes a second and third resistor connected in series, and a resistance varying element connected in parallel with the third resistor.

10. The reference voltage generator of claim 9, wherein the resistance varying element is configured to be adjustable such that the first voltage generating circuit generates a desired voltage value at the selected temperature value.

11. The reference voltage generator of claim 10, wherein the desired voltage value is the second voltage.

12. The reference voltage generator of claim 8, wherein the second voltage generator includes a proportional to absolute temperature element connected in series with a complementary to absolute temperature element.

13. The reference voltage generator of claim 12, wherein the proportional to absolute temperature element is a resistor and the complementary to absolute temperature element is a transistor.

14. The reference voltage generator of claim 1, wherein the reference voltage generating circuit generates the reference voltage such that the reference voltage decreases with increases in temperature.

15. A voltage reference generator, comprising:
a first voltage generator generating a first voltage;
a second voltage generator generating a second voltage; and
a voltage subtractor respectively weighting the first and second voltages and subtracting the weighted first voltage from the weighted second voltage to produce the reference voltage.

16. The reference voltage generator of claim 15, wherein the voltage subtractor is configured to selectively vary the respective weights, and varying the respective weights causes the temperature coefficient of the reference voltage to vary.

17. The reference voltage generator of claim 16, wherein
the second voltage generator generates a temperature independent voltage; and
the first voltage generator generates a temperature dependent voltage.

18. The reference voltage generator of claim 17, wherein
the first voltage generator generates the first voltage having a same voltage value as the second voltage at a desired temperature; and
the voltage substractor generates a same reference voltage value regardless of the temperature coefficient of the reference voltage at the desired temperature.

19. The reference voltage generator of claim 15, wherein the voltage subtractor produces the reference voltage such that the reference voltage decreases with increases in temperature.

20. A method of generating a reference voltage, comprising:
generating a reference voltage that changes with temperature and at a selected temperature value is a same voltage value regardless of a temperature coefficient of the reference voltage.

21. The method of claim 20, wherein the generating step comprises:
combining a first voltage and a second voltage to produce the reference voltage.

22. The method of claim 21, wherein the first voltage is a temperature dependent voltage, and the second voltage is a temperature independent voltage.

23. The method of claim 22, wherein the first voltage changes proportional to temperature.

24. The method of claim 22, wherein the generating step further comprises:
weighting the first and second voltages; and wherein
the combining step subtracts the weighted first voltage from the weighted second voltage.

25. The method of claim 24, wherein the generating step further comprises:
selectively varying the respective weights to vary the temperature coefficient of the reference voltage.

26. The method of claim 25, further comprising:
generating the first voltage based on a resistance value; and
generating the second voltage.

27. The method of claim 26, wherein the generating the first voltage step includes adjusting the resistance value such that the first voltage is a desired voltage value at the selected temperature value.

28. The method of claim 27, wherein the desired voltage value is the second voltage.

29. The method of claim 20, further comprising:
generating the second voltage; and
generating the first voltage such that the first voltage has a same voltage value as the second voltage at the desired temperature.

30. The method of claim 20, wherein the generating step generates the reference voltage such that the reference voltage decreases with increases in temperature.

31. A display driver circuit, comprising:
a voltage generator generating a gate driver voltage and a source driver voltage, the voltage generator including a reference voltage generator, the reference voltage generator generating a reference voltage that changes with temperature and at a selected temperature value is a same voltage value regardless of a temperature coefficient of the reference voltage, and the voltage generator generating at least the gate driver voltage based on the reference voltage;
a source driver generating driver signals for a display panel based on the source driver voltage; and
a gate driver generating gate driving signals for the display panel based on the gate driver voltage.

32. The display driver circuit of claim 31, wherein
the reference voltage generator generates a reference voltage that decreases with increases in temperature such that voltages of the gate driving signals decrease as the temperature increases.

33. The display driver circuit of claim 32, wherein the display panel is a liquid crystal display panel.
